(19) United States
(12) Patent Application Publication
(10) Pub. No.: US 2022/0380573 A1
(43) Pub. Date: Dec. 1, 2022

(54) GERM-REPELLENT ELASTOMER

(71) Applicant: Nano and Advanced Materials Institute Limited, Hong Kong (HK)

(72) Inventors: Xianqiao LIU, Hong Kong (HK); Qi JIANG, Hong Kong (HK); Yueying CHEN, Hong Kong (HK)

(21) Appl. No.: 17/868,821

(22) Filed: Jul. 20, 2022

Related U.S. Application Data
(63) Continuation-in-part of application No. 16/406,012, filed on May 8, 2019.
Application No. 16/406,012 is a continuation-in-part of application No. 16/032,049, filed on Jul. 10, 2018, now abandoned.
Application No. 16/032,049 is a continuation-in-part of application No. 16/032,052, filed on Jul. 10, 2018, now abandoned.

(51) Int. Cl. C08K 5/11

(52) U.S. Cl. CPC C08K 5/11

(57) ABSTRACT

A biocide-free, germ-repellent, crosslinked thermoset elastomer is provided. The elastomer base is a thermoset elastomer base selected from natural rubber, synthetic rubber, solid or liquid silicone rubber, or mixtures thereof. At least one germ-repelling modifier is selected from one or more of polyethylene glycol, a polyethylene glycol derivative, alcohol ethoxylate, a polymer including an isocyanate group, a polymer including an allyloxy group, siloxane, polyether modified silicone, polysorbates and copolymers or mixtures thereof. The germ-repelling modifier is permanently bonded to the thermoset elastomer base through a chemical reaction during extrusion, molding, or curing. This chemical reaction also crosslinks the thermoset elastomer base.

### CROSS-REFERENCE TO RELATED APPLICATIONS

The present application is a continuation-in-part of U.S. Non-Provisional patent application Ser. No. 16/406,012 which is a continuation-in-part of U.S. Non-Provisional patent application Ser. No. 16/032,049 filed Jul. 10, 2018, and a continuation-in-part of U.S. Non-Provisional patent application Ser. No. 16/032,052 filed Jul. 10, 2018, the disclosures of which are incorporated herein by reference in their entirety.

### FIELD OF INVENTION

The present invention provides a germ-repellent thermoset, crosslinked elastomer and an article containing the germ-repellent thermoset, crosslinked elastomer.

### BACKGROUND

Elastomers are soft, flexible and versatile polymers for ranges of applications such as seals, molded flexible parts, cooking utensils and shoes soles. Conventionally, antimicrobial agents are typically added to the plastics for antibacterial capability, especially for food contact products. However, this bears the risk to have the potentially harmful biocidal contents leaching into foodstuffs. Moreover, the slow-release of biocides that kills bacteria, potentially lead to the evolution of drug-resistant bacteria.

### SUMMARY OF INVENTION

The present invention provides a biocide-free, germ-repellent, crosslinked thermoset elastomer. The elastomer is made using conventional curing or reactions during extrusion or molding. No high-energy processes such as plasma treatment are required. The formed polymer is electrically neutral as a result. The elastomer base is a thermoset elastomer base selected from natural rubber, synthetic rubber, solid or liquid silicone rubber, or mixtures thereof At least one germ-repelling modifier is selected from one or more of polyethylene glycol, a polyethylene glycol derivative, alcohol ethoxylate, a polymer including an isocyanate group, a polymer including an allyloxy group, siloxane, polyether modified silicone, polysorbates and copolymers or mixtures thereof. The germ-repelling modifier is permanently bonded to the thermoset elastomer base through a chemical reaction during extrusion, molding, or curing. This chemical reaction also crosslinks the thermoset elastomer base.

This Summary is intended to provide an overview of the present invention and is not intended to provide an exclusive or exhaustive explanation.

### BRIEF DESCRIPTION OF THE DRAWINGS

FIG. 1 shows a series of pictures of agar plates depicting bacteria colonies (E. coli and S. aureus) retrieved from the plastic surfaces of the HCR control (Elastosil R401/70), L4 and L6 after an incubation period of 24 hours. Note the CFU in the control for E. coli and S. aureus are in the order of 3 and 4 logs respectively.

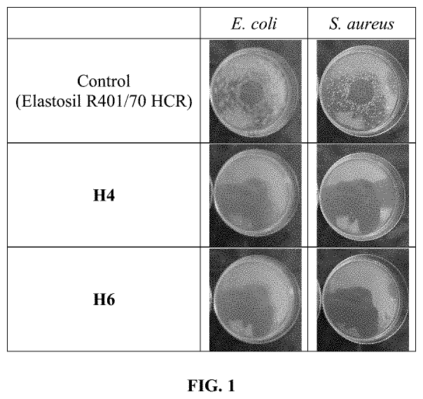

### DETAILED DESCRIPTION OF INVENTION

The present invention is not to be limited in scope by any of the following descriptions. The following examples or embodiments are presented for exemplification only.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a concentration range of “about 0.1% to about 5%” should be interpreted to include not only the explicitly recited concentration of about 0.1 wt. % to about 5 wt. %, but also the individual concentrations (e.g., 1%, 2%, 3%, and 4%) and the sub-ranges (e.g., 0.1% to 0.5%, 1.1% to 2.2%, and 3.3% to 4.4%) within the indicated range.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### Definitions

The singular forms “a,”, “an” and “the” can include plural referents unless the context clearly dictates otherwise.

The term “about” can allow for a degree of variability in a value or range, for example, within 10%, or within 5% of a stated value or of a stated limit of a range.

The term “independently selected from” refers to referenced groups being the same, different, or a mixture thereof, unless the context clearly indicates otherwise. Thus, under this definition, the phrase “X1, X2, and X3 are independently selected from noble gases” would include the scenario where, for example, X1, X2, and X3 are all the same, where X1, X2, and X3 are all different, where X1 and X2 are the same but X3 is different, and other analogous permutations.

The term “phr” defines as the per hundred rubber, which refers to the compound ingredients given as parts per 100 unit mass of the rubber polymer, which is prevalently referred as the polymeric base resin.

Selection of Thermoset Elastomer Base

The thermoset elastomer base may be natural rubber, synthetic rubber, solid or liquid silicone rubber, or mixtures thereof.

Silicone is one of the most versatile thermoset polymers for medical and food-grade applications due to its highly inert chemistry and strong silicon-oxygen bonding. Herein, two major kinds of silicone resins have been investigated, namely platinum-cured liquid silicone rubber (LSR) and peroxide-cured high consistency rubber (HCR). The following rubbers were selected (Table 1):

TABLE 1
Material list for silicone rubber

| Liquid Silicone Rubber (LSR) | High Consistency Rubber (HCR) |
|---|---|
| Sylgard 184 (Dow Corning) | Cenusil R270 (Wacker) |
| Silopren LSR2060 (Momentive) | Elastosil R401/70 (Wacker) |

Germ-Repelling Modifier:

Various materials may be used for the germ-repelling modifier. In particular, the germ-repelling modifier may be one or more of polyethylene glycol, a polyethylene glycol derivative, alcohol ethoxylate, a polymer including an isocyanate group, a polymer including an allyloxy group, siloxane, polydimethyisiloxane, polyurethane, polyether modified silicone, polysorbates and copolymers or mixtures thereof. As will be discussed in further detail below, the germ-repelling modifier is permanently bonded to the thermoset elastomer base through a chemical reaction during extrusion, molding, or curing. This chemical reaction also crosslinks the thermoset elastomer base. Particular examples of the germ-repelling modifier are set forth below.

To impart germ-repellent properties into the silicone rubber, different modifiers were incorporated into the base materials (LSR and HCR). The effective modifiers can be polyethylene glycol (PEG), polypropylene glycol (PPG), PEG or PPG terminated, or copolymers with side chains of PEG or PPG groups, as indicated in Table 2.

TABLE 2
Material list for additives to be used for modifying silicone

| Name | Brand | Chemical Formula | HLB Number |
|---|---|---|---|
| ENEA-0260 Allyloxy(polyethylene)oxide | Gelest | 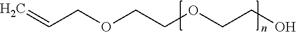 | 5-8 |
| CMS-222 (Hydroxypropyleneyl) methylsiloxane-dimethyl siloxane copolymer | Gelest | 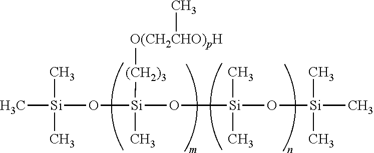 | 1.5 |
| SIA0479.0 O-allyloxy(polyetheneoxy) trimethylsilane | Gelest | 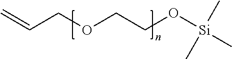 | N/A |
| OFX-0193 silicone polyether copolymer | Dow Corning | 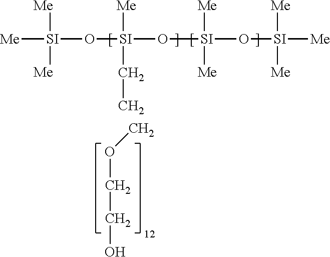 | 12.2 |
| PEG 200 Polyethylene glycol, Mw.200 | Kermel_Tianjing | 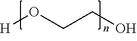 | 9.1 |
| PEG 400 Polyethylene glycol, Mw.400 | Kermel_Tianjing | 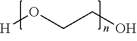 | 12.9-13.1 |
| mPEG 600 Methyl polyethylene glycol, Mw.600 | Chenrun_Nantong | 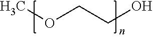 | 19.5 |
| TWEEN®80 Polyoxyethylenesorbitan monooleate | Sigma | 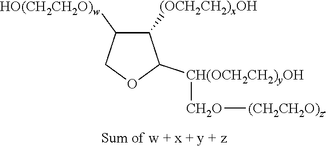 | 15 |

The difference between HCR and LSR lies on their viscosities and hence different processing procedures are used to prepare samples of each type. LSR is generally in the form of part A and part B. The two parts are mixed and heat cured in the presence of platinum curing agent. LSR can be applied to extrusion or injection molded products, examples are sealants, O-rings, tubing, baby bottle nipples, small medical inserts, etc. HCR generally exists in a gum form. It can be heat-cured in the presence of peroxide curing agents. HCR can be compression-molded into desired shapes, or extruded into calendared sheets for mold-cutting into e.g., sealants, culinary mats and containers, etc.

### Examples

Preparation of Germ-Repellent Silicone

The germ repellent silicone (LSR) sample could be prepared by separately weighing Part A (hydride-rich polydimethylsiloxane oligomers) and Part B (vinyl-rich polydimethylsiloxane oligomers) of LSR system into a clean plastic cup. Then specific amounts of modifier in phr are added into the same cup. As an example, in the preparation of L4 (LSR2060/5 phr ENEA-0260), 25 g of Part A, 25 g of Part B and 2.5 g of ENEA-0260 were weighed into a clean cup. A high-speed mixer operating at 2000 rpm for 5 mins was used for the mixing. The mixing could also be accomplished in a liquid injection molding (LIM) machine, where the LSR and the liquid modifier could be fed into and mixed in the injection screw as a single mixing step. After mixing, a hot-press preheated to 175° C. was used to partially cure and to simultaneously thermoform the LSR into sheets. The samples were then post-cured for 4 hours in an oven, at a regulated temperature between 175° C.-200° C. to ensure the silicone samples are fully cured and to remove any remaining volatile organic matters. The sheets were cut into desired 4 cm×4 cm plastic sheet for germ-repellency evaluation or die-cut into sample specimens according to the relevant ASTM standard for mechanical properties determination.

For germ-repellent HCR, H4 as an example, 1 kg of HCR gum and 1% (10 g) of silicone gel containing a peroxide-based curing agent, 2,5-dimethyl-2,5-di(tert-butylperoxy)hexane, are weighed and kneaded in a two-roll mill. The gum softens as it is being kneaded but no curing occurs at this step. Then 5 phr (i.e., 50 g) of the modifier, ENEA-0260, was added gradually and into the softened silicone using a plastic pipette. Aliquots were added in multiple phases to avoid slipping the silicone from the roll drum. The heterogeneous silicone would feel sticky to the hands. With repeated compressing and folding cycles in the two roll-mill, sufficient mixing of the germ-repellent modifier could be achieved as apparent from the non-sticky characteristic of the well-mixed silicone gum. Then 300-400 g of the well-mixed silicone gum was cured and pressed into either sheets using compression molds at 180° C. for 2-3 minutes at a mold pressure of 2-3 MPa. The GR modified HCR silicone sheets were post-cured for 4 hours at 200° C. to ensure the silicone samples were fully cured and free of remaining volatile organic matters. The sheets were cut into desired 4 cm×4 cm plastic sheet for germ-repellency evaluation or die-cut into sample specimens according to the relevant ASTM standard for mechanical properties determination. The thermoforming conditions employed for the silicone are summarized in Table 3.

TABLE 3
Curing condition for silicone rubbers

| | Liquid Silicone Rubber (LSR) | | High Consistency Rubber (HCR) | |
|---|---|---|---|---|
| Model | Sylgard 184 | LSR2060 | Cenusil R 270 | Elastosil R401/70 |
| Curing | Platinum | Platinum cured | Peroxide cured | Peroxide cured |
| agent | cured | | | |
| Curing | 1^{st} Curing | 1^{st} Curing | 1^{st} Curing | 1^{st} Curing |
| temperature | 60 ° C., oven, | 175 ° C., hot-press | 175 ° C., hot-press | 175 ° C., hot-press |
| | 24 hours | machine, 2 mins; | machine, 2 mins; | machine, 2 mins; |
| | | 2^{nd} Curing | 2^{nd} Curing | 2^{nd} Curing |
| | | 200 ° C., oven, 4 | 200 ° C., oven, 4 | 200 ° C., oven, 4 |
| | | hours | hours | hours |

Germ-Repellent Modification on Sylgard 184

According to our preliminary work in other plastics, PEGs can give an excellent germ-repellent performance. In the initial phase for the evaluation of germ-repellent capacity of silicones, Sylgard 184, which is a low viscosity polydimethylsiloxane (PDMS) and has the merit of easy preparation, was selected for blending with PEGs. Formulations based on Sylgard 184 are shown in Table 4:

TABLE 4
Formulation matrix for Sylgard 184

| | Base Resin | Modifiers | | | | |
|---|---|---|---|---|---|---|
| | Sylgard | PEG | PEG | mPEG | OFX- | Tween |
| No. | 184 | 200 | 400 | 600 | 0193 | 80 |
| S1 | 100 | 5 | — | — | — | — |
| S2 | 100 | — | 5 | — | — | — |
| S3 | 100 | — | — | 5 | — | — |
| S4 | 100 | — | — | — | 1 | — |
| S5 | 100 | — | — | — | 3 | — |
| S6 | 100 | — | — | — | 5 | — |
| S7 | 100 | — | — | — | — | 1 |
| S8 | 100 | — | — | — | — | 3 |

Germ-Repellent Efficacy of Modified Sylgard 184

Functional test of the present invention suggested that germ-repellency could be imparted to the low viscosity polydimethylsiloxane Sylgard 184 with the polyethylene glycol-based modifiers. OFX-0193 was demonstrated to be an effective germ-repellent modifier for Sylgard 184, with bacterial reduction of up to 99% against both E. coli and S. aureus (Table 5, entry S5 and S6) as determined by counting the colonies forming units on culture plates (FIG. 8). Germ-repellency against E. coli could also be observed in S2, S3, S7 and S8 with PEG 400, mPEG 600 and Tween 80, with bacterial reduction of up to 100%.

The OFX-0193 modified Sylgard 184 has excellent germ-repellency towards both E. coli and S. aureus; but the PDMS turns increasingly opaque with increasing concentration (FIG. 7). In optimizing the optical property and the germ-repellent efficacy, S5 containing 3 phr of OFX-0193 in Sylgard 184 could represent the optimal choice.

TABLE 5
Relative bacterial colony counts of E. coli and S. aureus from swab
tests of the modified and unmodified Sylgard 184 samples; symbol “+”
indicates an increased number of colonies relative to the control

| | S1 | S2 | S3 | S4 | S5 | S6 | S7 | S8 |
|---|---|---|---|---|---|---|---|---|
| E. coli | + | −100% | −100% | −50% | −99+% | −99+% | −100% | −98% |
| S. aureus | + | + | + | −99+% | −99+% | −99+% | −17% | −58% |

Germ-Repellent Modification on LSR2060

OFX-0193 and additional modifiers (ENEA-0260, CMS-222 and SIA0479.0) were selected for germ-repellent modification of LSR2060. All modifiers are derivatives of polyethylene glycol or polypropylene glycol. Table 6 shows the formulations for the modification of LSR2060:

TABLE 6
Formulation for LSR2060; all values are in phr (per hundred rubber)

| | Base | Modifiers | | | |
|---|---|---|---|---|---|
| | Resin | OFX-0193 | ENEA-0260 | CMS-222 | SIA0479.0 |
| No. | LSR2060 | Blend | Reactive | Blend | Reactive |
| L1 | 100 | 5 | — | — | — |
| L2 | 100 | — | 1 | — | — |
| L3 | 100 | — | 3 | — | — |
| L4 | 100 | — | 5 | — | — |
| L5 | 100 | — | — | 5 | — |
| L6 | 100 | — | — | — | 5 |

Germ-Repellent Efficacy of Modified LSR2060

In the experimental matrix, the germ-repellency of LSR2060 with four kinds of polyglycols and silicone copolymers modifiers were evaluated. Formulations with 3 phr or above ENEA-0260 (i.e., L3 and L4) and 5 phr SIA0479.0 (L6) show excellent germ-repellency, with bacterial reduction of up to 100% against both E. coli and S. aureus (Table 7) as determined by counting the colonies forming units on culture plates (FIG. 9). LSR2060 modified with 5 phr CMS-222 (polypropylene glycol-silicone copolymer) as in L5, could also demonstrate germ-repellency with greater than one log reduction (−93%) against E. coli.

TABLE 7
Relative bacterial colony counts of E. coli and
S. aureus from swab tests of the modified and unmodified
LSR0260 samples; symbol “+” indicates an
increased number of colonies relative to the control

| | L1 | L2 | L3 | L4 | L5 | L6 |
|---|---|---|---|---|---|---|
| E. coli | −25% | −39% | −100% | −99+% | −93% | −99+% |
| S. aureus | −94% | + | −100% | −100% | + | −100% |

Cytotoxicity of Germ-Repellent Silicone L4

MTT assays were performed on L4 and also on the base material, LSR2060, as shown in FIG. 10. The level of cytotoxicity was evaluated towards the L929 cell line (mouse fibroblast). Excellent biocompatibility is observed with L4 with cell viability of L929 cell lines up to 104%, higher than that of the base material (88%). Latex was used as the positive control which showed 14% cell viability. This data suggests the germ-repellent modified LSR has good biocompatibility with living cells.

Germ-Repellent Modification of HCR

Successful formulations for LSR are experimented in two different models of HCR to assess the feasibility of developing GR HCR. Initial experiments have been conducted at 3 phr for ENEA-0260, 5 phr for CMS-222 and 2 phr for SIA0479.0, as listed in Table 8. These modifier concentrations have been selected based on favorable results from the LSR counterparts. OFX-0193 has not been formulated for HCR as it cannot withstand heating to 200° C. for extended periods. It is observed that germ-repellence efficacy may dependent on the base resin. Cenusil R401 demonstrates germ-repellency effect more readily than the R270 counterpart, which has a hardness of Shore A 70 rather than Shore A 55 in R401. Formulation H5, with a polypropylene glycol-polydimethylsiloxane copolymer (non-polyethylene glycol-based modifier) appears to possess some germ-repellent effect.

TABLE 8
Experimental matrix for formulating GR HCR (in phr units)

| | Base Resin | | | | |
|---|---|---|---|---|---|
| | Cenusil | Elastosil | Modifiers | | |
| No. | R270 | R401/70 | ENEA0260 | CMS-222 | SIA 0479.0 |
| H1 | 100 | — | 3 | — | — |
| H2 | 100 | — | — | 5 | — |
| H3 | 100 | — | — | — | 2 |
| H4 | — | 100 | 3 | — | — |
| H5 | — | 100 | — | 5 | — |
| H6 | — | 100 | — | — | 2 |

Germ-Repellent Efficacy of Modified HCR

HCR formulations with 3 phr ENEA-0260 (i.e., H1 and H4), 5 phr CMS-222 (i.e., H5) and 2 phr of SIA0479.0 (H6) all show excellent germ-repellency, with bacterial reduction of up to 100% against both E. coli and S. aureus (Table 9) as determined by counting the colonies forming units on culture plates (FIG. 11). Cenusil R270 HCR base resin modified with 5 phr SIA0479.0 as in H3, also demonstrate excellent germ-repellency with greater than one log reduction (−98%) against E. coli.

TABLE 9
Relative bacterial colony counts of E. coli and S. aureus from
swab tests of the modified and unmodified HCR samples; symbol “+”
indicates an increased number of colonies relative to the control

| | H1 | H2 | H3 | H4 | H5 | H6 |
|---|---|---|---|---|---|---|
| E. coli | −100% | −59% | −60% | −100% | −100% | −100% |
| S. aureus | −100% | + | −98% | −100% | −100% | −100% |

Mechanical Properties of Germ-Repellent Silicone

The following physical properties (1) Hardness; (2) Density; (3) Tensile strength; (4) Elongation; (5) Tear strength; (6) Compression set, were determined for the selected GR-modified LSR (L4), GR-modified HCR (H4), and the corresponding unmodified controls (Table 10). All parameters of the formulations and the unmodified control have been determined under the same laboratory condition and according to the ASTM standard. Except the compression set of H4 being 61%, which is +61% compared with the unmodified control (38%), the mechanical properties parameters of both GR formulations, are within 20% of the unmodified control.

TABLE 10
Mechanical properties of L4 and H4 and the respective control
determined under the same laboratory condition

| | | | L4 | | H4 |
|---|---|---|---|---|---|
| | | | 5 phr | Control | 3 phr |
| | | Control | ENEA- | Cenusil | ENEA- |
| | | LSR2060 | 0260 | R401/70 | 0260 |
| Shore | ASTM | 62A | 61A (−2%) | 72A | 70A (−3%) |
| Hardness | D2240 | | | | |
| Specific | ASTM | 1.14 | 1.14 | 1.19 | 1.19 |
| gravity | D792 | | | | |
| (g/cm³) | | | | | |
| Tensile | ASTM | 6.5 | 5.8 (−11%) | 9.0 | 7.3 (−19%) |
| strength | D412 | | | | |
| (N/mm²) | | | | | |
| (Die C) | | | | | |
| Elongation | | 445% | 497% (+12%) | 924% | 1077% (+17%) |
| (% at | | | | | |
| break) | | | | | |
| Tear | ASTM | 35.5 | 29.9 (-16%) | 22.5 | 26.3 (+17%) |
| strength | D624 | | | | |
| (N/mm) | | | | | |
| (Die C) | | | | | |
| Compres- | ASTM | 28.6% | 33% (+15%) | 38% | 61% (+61%) |
| sion | | | | | |
| set (%) | D395 | | | | |
| (22 h at | | | | | |
| 175°) | | | | | |

### INDUSTRIAL APPLICABILITY

The present invention is useful in making a germ-repelling article which is non-leaching, non-carcinogenic and non-toxic for the improvement in public health. Furthermore, it is safe for food contact, medical and consumer applications.

1. A biocide-free, germ-repellent, crosslinked thermoset elastomer comprising:
a thermoset elastomer base selected from natural rubber, synthetic rubber, solid or liquid silicone rubber, or mixtures thereof;
at least one germ-repelling modifier selected from one or more of polyethylene glycol, a polyethylene glycol derivative, alcohol ethoxylate, a polymer including an isocyanate group, a polymer including an allyloxy group, siloxane, polydimethylsiloxane, polyurethane, polyether modified silicone, polysorbates and copolymers or mixtures thereof;
the at least one germ-repelling modifier being permanently bonded to the thermoset elastomer base through a chemical reaction during extrusion, molding, or curing, wherein the chemical reaction also crosslinks the thermoset elastomer base.

2. The biocide-free, germ-repellent, crosslinked thermoset elastomer according to claim 1, wherein the thermoset base elastomer is liquid silicone rubber.

3. The biocide-free, germ-repellent, crosslinked thermoset elastomer according to claim 1, wherein the thermoset base elastomer is high consistency rubber (HCR).

4. The polyurethane, polyether biocide-free, germ-repellent, crosslinked thermoset elastomer according to claim 1, wherein the thermoset base elastomer is natural rubber.

5. The biocide-free, germ-repellent, crosslinked thermoset elastomer according to claim 1, wherein the thermoset elastomer base is synthetic rubber.

6. The biocide-free, germ-repellent, crosslinked thermoset elastomer according to claim 1, where the germ-repelling modifier is chemically bond to the thermoset elastomer base through reaction extrusion processing

7. The biocide-free, germ-repellent, crosslinked thermoset elastomer according to claim 1, wherein the germ-repelling modifier is chemically bond to the thermoset elastomer base through copolymerization between polyethylene glycol or a polyethylene glycol derivative and the thermoset elastomer base.

8. The biocide-free, germ-repellent, crosslinked thermoset elastomer according to claim 1, wherein the thermoset elastomer base is silicone rubber and the mass ratio of the silicone rubber substrate to the germ-repelling modifier is 100:(2-10).

9. The biocide-free, germ-repellent, crosslinked thermoset elastomer according to claim 8, wherein the silicone rubber base includes component A and component B, and component A includes polydimethylsiloxane with vinyl groups and component B includes polydimethylsiloxane with functional groups.

10. The biocide-free, germ-repellent, crosslinked thermoset elastomer according to claim 9, wherein the germ-repelling modifier includes a polyethoxylated non-ionic surfactant, wherein the polyethoxylated non-ionic surfactant is selected from a combination of polyethylene glycol or a polyethylene glycol derivative and silicone oil.

11. The biocide-free, germ-repellent, crosslinked thermoset elastomer according to claim 8, wherein the mass ratio of the silicone rubber base to the germ-repelling modifier is 100:(2-3).

12. The biocide-free, germ-repellent, crosslinked thermoset elastomer according to claim 9, wherein the mass ratio of component A to component B is (0.5-1.5):(0.5-1.5).

13. The biocide-free, germ-repellent, crosslinked thermoset elastomer according to claim 10, wherein the mass ratio between polyethylene glycol or the polyethylene glycol derivative and silicone oil is (60-40):(40-60).

14. The biocide-free, germ-repellent, crosslinked thermoset elastomer according to claim 1, wherein the polyethylene glycol or the polyethylene glycol derivative comprises PEG 200, PEG 400, mPEG 600, and poly(ethylene glycol) sorbitol hexaoleate.
